(19) United States
(12) Patent Application Publication
(10) Pub. No.: US 2016/0261027 A1
(43) Pub. Date: Sep. 8, 2016

(54) RADIATOR FRAME, ELECTRONIC DEVICE INCLUDING THE SAME, AND MOLD FOR MANUFACTURING THE SAME

(71) Applicant: Samsung Electro-Mechanics Co., Ltd., Suwon-si (KR)

(72) Inventors: Hyun Do PARK, Suwon-si (KR); Ye Ji PARK, Suwon-si (KR); Jun Seung YI, Suwon-si (KR); Chan Gwang AN, Suwon-si (KR); Hyeon Gil NAM, Suwon-si (KR); Ha Ryong HONG, Suwon-si (KR); Sung Eun CHO, Suwon-si (KR); Dae Kyu LEE, Suwon-si (KR); Dae Seong JEON, Suwon-si (KR); Dae Ki LIM, Suwon-si (KR)

(73) Assignee: Samsung Electro-Mechanics Co., Ltd., Suwon-si (KR)

(21) Appl. No.: 14/972,617

(22) Filed: Dec. 17, 2015

(30) Foreign Application Priority Data
Mar. 4, 2015 (KR) 10-2015-0030258

(51) Int. Cl. H01Q 1/24; H01Q 9/04; B29C 45/14; H01Q 1/40

(52) U.S. Cl. CPC H01Q 1/243; H01Q 1/40; H01Q 9/04; B29C 45/14073; B29C 45/14819; B29C 2045/14081; B29C 2045/14163; B29L 2031/3437

(57) ABSTRACT

Disclosed is a radiator frame and a method of manufacturing the radiator frame. The radiator frame includes a radiator comprising an antenna pattern configured to transmit or receive a signal and a terminal connection configured to electrically connect the antenna pattern to a circuit board, and a molding frame configured to embed the radiator, wherein the antenna pattern is embedded in a first surface of the molding frame, and the terminal connection is exposed to a second surface of the molding frame.

### CROSS-REFERENCE TO RELATED APPLICATION(S)

This application claims the priority and benefit under 35 USC 119(a) of Korean Patent Application No. 10-2015-0030258 filed on Mar. 4, 2015 in the Korean Intellectual Property Office, the entire disclosure of which is incorporated herein by reference for all purposes.

### BACKGROUND

1. Field

The following description relates to a radiator frame having an antenna pattern embedded therein, an electronic device including the same, and a mold for manufacturing the radiator frame having an embedded antenna pattern.

2. Description of Related Art

Mobile communications terminals such as, for example, mobile phones, personal digital assistants (PDAs), GPS navigation devices, laptop computers supporting wireless communications are used abundantly in modern societies. Such mobile communications terminals have been developed to include communication schemes such as code division multiple access (CDMA), wireless local area network (WLAN), global system for mobile communications (GSM), and digital multimedia broadcasting (DMB). A component of the mobile communications terminals that enable these communication schemes is an antenna.

An antenna used in mobile communications terminals has evolved from an external type antenna, such as a rod antenna or a helical antenna, to an embedded type antenna disposed within the terminal. The external type antenna may be vulnerable to external impacts, while the embedded type antenna may increase a volume of the terminal. In order to solve these problems, research into technology for integrating antennas into mobile communications terminals has been actively conducted.

Injection-molding a radiator to form a radiator frame and directly utilizing the radiator frame has been used. When the radiator frame is injection-molded, a painting task is additionally required after the radiator frame is injection-molded. However, a terminal portion is also partially painted by a scattering of a painting material during the painting task, and thus undesirable contact between the terminal portion and a substrate may occur in the painting process.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a radiator frame including a radiator including an antenna pattern configured to transmit or receive a signal and a terminal connection configured to electrically connect the antenna pattern to a circuit board, and a molding frame configured to embed the radiator, wherein the antenna pattern is embedded in a first surface of the molding frame, and the terminal connection is exposed to a second surface of the molding frame.

A supporting groove may be provided in a portion of the second surface of the molding frame.

The antenna pattern may be embedded in the molding frame to be spaced apart from one surface of the molding frame by about 0.2 mm.

The radiator may be embedded in the molding frame by injection-molding a resin.

The antenna pattern may be embedded in the molding frame to be spaced apart from one surface of the molding frame by about 0.2 mm to 0.5 mm.

The antenna pattern and the terminal connection may be disposed in different planes.

In another general aspect, there is provided a mold for manufacturing a radiator frame, the mold including an upper mold including at least one guide pin, a lower mold including a supporting pin, and the lower mold combines with the upper mold to provide an internal space to accommodate a radiator including an antenna pattern, and a resin injector provided in at least one of the upper mold and the lower mold to inject a resin into the internal space, wherein the at least one guide pin and the supporting pin fix the antenna pattern in the internal space, and the at least one guide pin combines with an elastic part to be retractable by a pressure of the resin injected into the internal space.

The mold elastic part may include an elastic member configured to have a first end attached to the guide pin, a support member configured to support a second end of the elastic member, a guide hole provided in the upper mold, and the at least one guide pin is inserted into the guide hole and a end of the at least one guide pin exposed to the internal space.

The elastic member may be a spring.

The quantity of the elastic member may be equal to a quantity of the at least one guide pin.

The supporting pin may protrude into the internal space.

The upper mold may have a groove of about 0.2 mm.

The end of the at least one guide pin exposed to the internal space may be retracted in the guide hole, in response to the pressure of the injected resin.

The at least one guide pin may not protrude into the internal space.

The pressure of the resin injected into the internal space may be sufficient to compress the elastic member.

Other features and aspects will be apparent from the following detailed description, the drawings, and the claims.

### BRIEF DESCRIPTION OF DRAWINGS

FIG. 1 is a diagram illustrating an example of a radiator frame being coupled to a case of a mobile communications terminal, which is an electronic device.

FIG. 2 is a diagram illustrating an example of a mobile communications terminal manufactured using a radiator frame.

FIG. 3 is a diagram illustrating an example of a radiator.

FIG. 4 is a diagram illustrating an example of a radiator frame.

FIG. 5 is a diagram illustrating an example of a cross-sectional view taken along line A-A′ of FIG. 4

FIG. 6 is a diagram illustrating an example of a manner in which a radiator is disposed in a mold and the mold is filled with a resin material, in a method for manufacturing a radiator frame.

Throughout the drawings and the detailed description, unless otherwise described or provided, the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations is described as an example; the sequence of operations is not limited to that set forth herein and may be changed as is known in the art, with the exception of steps and/or operations that necessarily occur in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure is thorough, complete, and conveys the full scope of the disclosure to one of ordinary skill in the art.

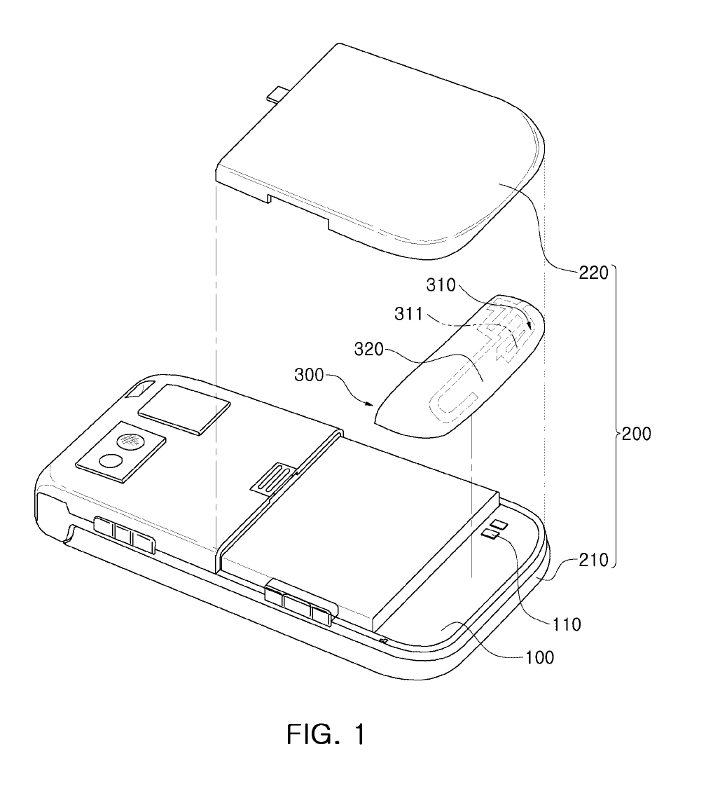

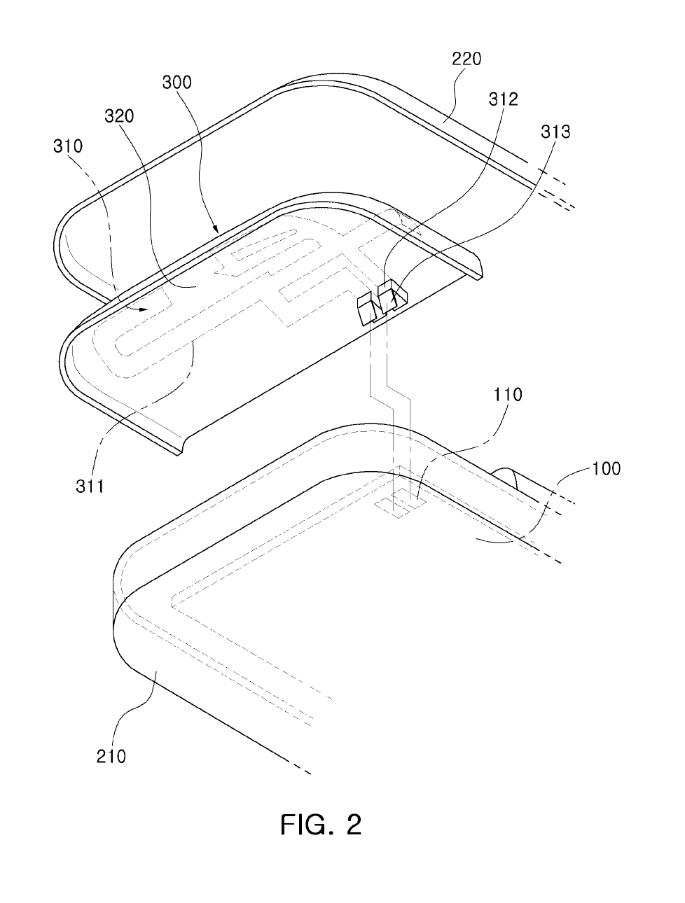

FIG. 1 is a diagram illustrating an example of a radiator frame coupled to a case of a mobile communications terminal. FIG. 2 is a diagram illustrating an example of a mobile communications terminal manufactured using a radiator frame.

Referring to FIGS. 1 and 2, an electronic device may include a circuit board 100, a housing 200, and a radiator frame 300.

Various kinds of boards 100, such as, for example, a ceramic substrate, or a printed circuit board (PCB) may be used.

One surface of the circuit board 100 may be provided with one or more electronic components, and may be provided with mounting electrodes for mounting the electronic components and wire patterns that electrically interconnect the mounting electrodes. In an example, the circuit substrate 100 may be a multilayer circuit board formed of a plurality of layers, and conductive vias (not illustrated) for electrically connecting respective layers may be formed between the respective layers.

The circuit board 100 may have a terminal 110 for forming a connection with a radiator 310. The radiator 310 may be electrically connected to the terminal 110 of the circuit board 100. The radiator 310 may serve as an antenna to receive an external signal, to transmit the received signal to the circuit board 100, and to transmit a signal received from the circuit board 100 externally.

The housing 200 is a member forming a shape of the electronic device. The housing 200 may include a front case 210 and a rear cover 220. The front case 210 may be coupled to a variety of electronic elements for driving the electronic device and the circuit board 100 described above.

The radiator frame 300 may be coupled to one side of the front case 210, and the rear cover 220 may be coupled to an upper surface of the radiator frame 300. The front case 210 and the rear cover 220 may be coupled to each other to enclose an internal space. The internal space may accommodate a variety of electronic elements that are needed for the electronic device, the circuit board 100, and the radiator frame 300.

The rear cover 220 may be coupled to the upper surface of the radiator frame 300 to prevent the radiator frame 300 from being externally exposed. The front case 210 and the rear cover 220 may be detachably coupled to each other. As an example, the rear cover 220 may be hook-coupled to the front case 210.

In an example, the front case 210 and the rear cover 220 may be formed of plastic, and may be formed by a method, such as, for example, injection-molding a resin. Other materials may be used for the front case 210 and rear cover 220 without departing from the spirit and scope of the illustrative examples described. Any material may be used for the front case 210 and rear cover 220, which can form a structure in which the electronic element, the circuit board 100, and the radiator frame 300 may be accommodated.

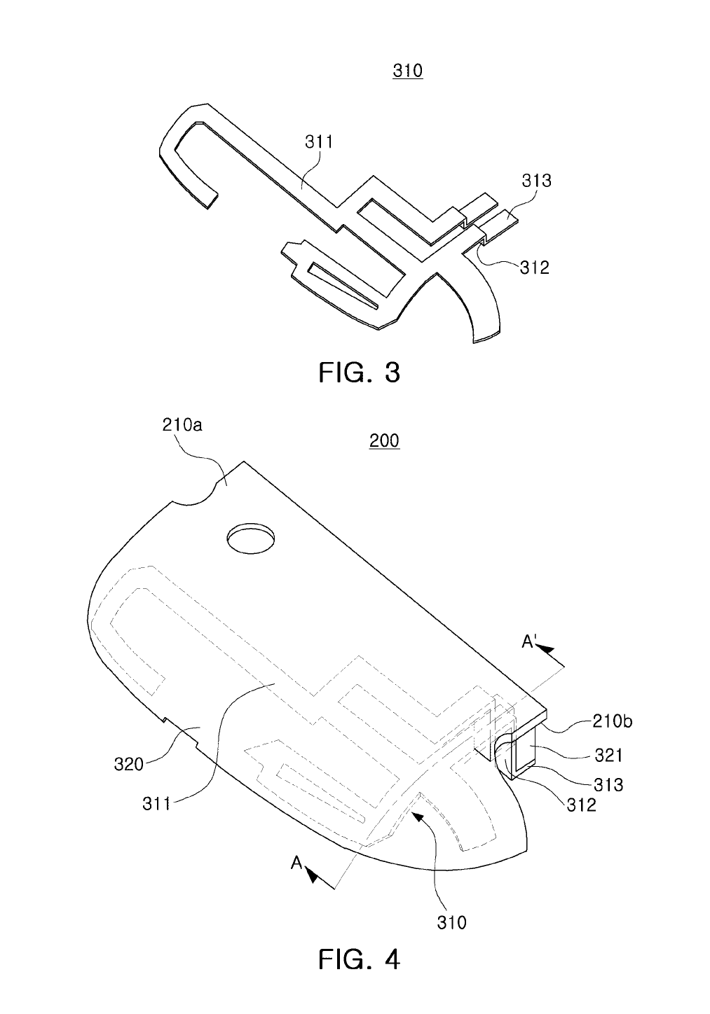

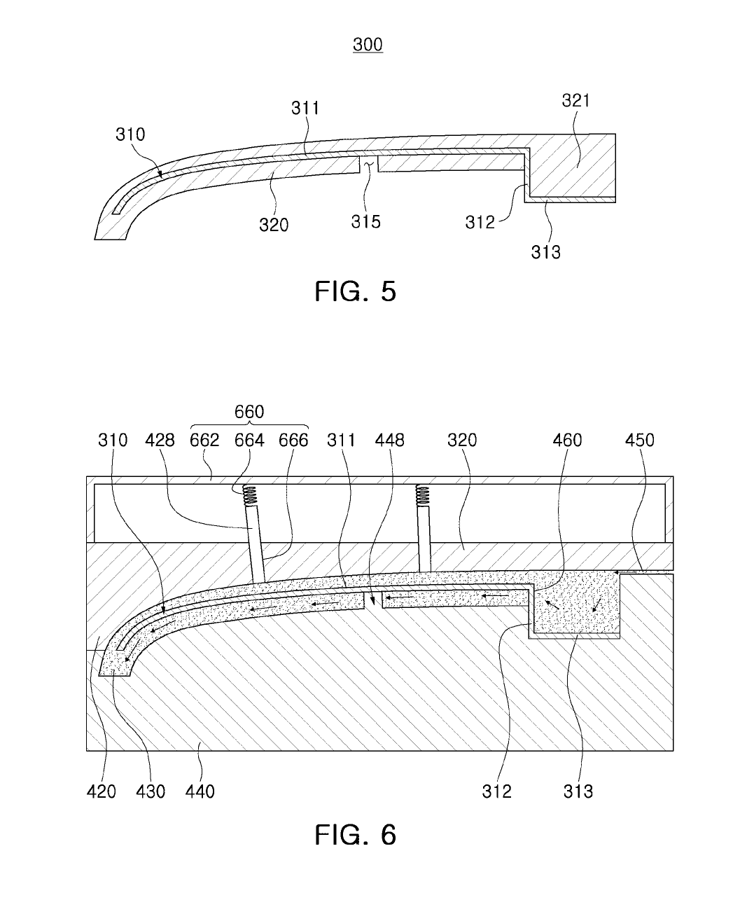

FIG. 3 is a diagram illustrating an example of the radiator 310. FIG. 4 is a diagram illustrating an example of the radiator frame 300, and FIG. 5 is a diagram illustrating an example of cross-sectional view taken along line A-A′ of FIG. 4.

FIG. 6 is a diagram illustrating an example of a method for manufacturing a radiator frame. FIG. 6 illustrates an example of a manner in which a radiator is disposed in a mold and the mold is filled with a resin material.

Referring to FIGS. 3 through 6, the radiator frame 300 may include the radiator 310 and a molding frame 320. The radiator 310 may include an antenna pattern part 311, a connecting part 312, and a terminal connection part 313.

The radiator 310 may be formed of a conductor such as, for example, aluminum or copper. The radiator 310 may receive an external signal to transmit the received signal to a signal processing device (not illustrated) included in the electronic device or may transmit a signal from the electronic device to an external receiving site.

The radiator 310 may include the antenna pattern part 311, the connecting part 312, and the terminal connection part 313. The radiator 310 may be formed to have a three dimensional structure by bending the antenna pattern part 311 and the terminal connection part 313.

The antenna pattern part 311 may transmit or receive signals. The antenna pattern part 311 may be shaped to meander in a curved, arc, or line fashion in order to receive external signals in various bands.

The connecting part 312 may connect the antenna pattern part 311 and the terminal connection part 313 to each other. The connecting part 312 may allow the antenna pattern part 311 and the terminal connection part 313 to be disposed on different planes. The connecting part 312 may allow the terminal connection part 313 that is not embedded in the molding frame 320 to be exposed to another surface of the molding frame 320 opposing a surface on which the antenna pattern part 311 is formed.

The terminal connection part 313 may electrically connect the antenna pattern part 311 to the circuit board 100 in order to transmit the received signal to the electronic device or externally transmit the output signal. The terminal connection part 313 is connected to the terminal 110 of the circuit board 100, whereby the radiator frame 300 mounted on the electronic device may implement antenna performance in the electronic device. In an example, the terminal connection part 313 may be elastically in contact with the terminal 110 to secure connection reliability.

In another example, although not specifically illustrated, at least one guide pin hole may be formed in the antenna pattern part 311 to prevent movement of the radiator 310 during injection-molding.

The molding frame 320 may be manufactured by injection-molding the radiator 310, i.e., the radiator is embedded in the molding frame by injection-molding. The molding frame 320 may be an injection-molded structure, the antenna pattern part 311 may be embedded in one surface 210a of the molding frame 320, and the terminal connection part 313 may be exposed to the other surface 210b of the molding frame 320. Surface 210b may oppose surface 210a of the molding frame 320. In an example, the antenna pattern part 311 may be embedded to be spaced apart from surface 210a of the molding frame 320 by 0.2 mm. In another example, the antenna pattern part 311 may be embedded to be spaced apart from the surface 210a of the molding frame 320 by 0.2 mm to 0.5 mm.

In an example, one surface of the molding frame 320 is defined as a surface opposing the rear cover 220, and the other surface of the molding frame 320 is defined as a surface opposing the circuit board 100.

A method for manufacturing the radiator frame 300 will be described with reference to FIGS. 5 and 6. As shown in FIG. 6, a mold 400 for manufacturing the radiator frame 300 may include an upper mold 420 and a lower mold 440. When the upper mold 420 and the lower mold 440 are combined, an internal space 430 may be formed by grooves provided in the upper mold 420 and the lower mold 440.

When the upper mold 420 and the lower mold 440 are combined, a resin injection part or resin injector 450 may be formed in any one or both of the upper and lower molds 420 and 440 to introduce a resin into the internal space 430 that is formed by combining the upper mold 420 and the lower mold 440.

Inner surfaces of the upper and lower molds 420 and 440 may form an accommodating groove 460 to accommodate the connecting part 312 and the terminal connection part 313 of the radiator 310. The resin may be introduced into the accommodating groove 460 to fixedly support the connecting part 312 and the terminal connection part 313. Since one side surface of the connecting part 312 is in contact with one side surface of the accommodating groove 460, the resin may be provided on only one side surface of the connecting part 312 to form a radiator supporting part 321. The radiator supporting part 321 formed by the resin introduced into the accommodating groove 460 may protrude to the other surface of the molding frame 320, which is the surface opposing one surface of the molding frame 320 in which the antenna pattern part 311 is formed.

The radiator frame 300 may be manufactured by disposing the radiator 310 in the internal space 430 of the mold 400 and then injecting a molding resin into the internal space 430.

The radiator 310 includes the antenna pattern part 311, the terminal connection part 313, and the connecting part 312. The antenna pattern part 311 transmits and receives the signal. The terminal connection part 313 is disposed on a different plane from that of the antenna pattern part 311. The connecting part 312 connects the antenna pattern part 311 and the terminal connection part 313 to each other may be disposed in the internal space 430 of the mold 400.

The lower mold 440 forming the manufacturing mold 400 may be capable of fixing the radiator 310 disposed in the internal space 430, more specifically, the antenna pattern part 311. In an example, at least one of the upper mold 420 and the lower mold 440 may include at least one of a guide pin 428 and a supporting pin 448.

The guide pin 428 and the supporting pin 448 may fixedly dispose the antenna pattern part 311 of the radiator 310 by supporting the radiator 310 at different positions.

For convenience of explanation, a description below is provided with the guide pin 428 being provided to the upper mold 420 and the supporting pin 448 being provided to the lower mold 440. Other arrangement and configuration of the supporting pin 448 and the guide pin 428 may be used without departing from the spirit and scope of the illustrative examples described.

The guide pin 428 provided to the upper mold 420 may maintain a state in which the guide pin 428 fixes the radiator 310 and may be then separated and retracted from the radiator 310 when the molding resin is pressurized to be injected into the internal space 430 of the manufacturing mold 400. Thereby, the antenna pattern part 311 of the radiator frame 300 may not be exposed to one surface of the molding frame 320.

The guide pin 428 provided to the upper mold 420 may fix the radiator 310 in the internal space 430 of the manufacturing mold 400. The guide pin 428 may work together with an elastic part 660 to be retractable by injection pressure of the resin that is injected into the internal space 430 from the resin injection part 450.

The elastic part 660 may include an elastic member 664 (e.g., a spring) having one end attached to the guide pin 428, a supporting member 662 supporting the other end of the elastic member 664, and a guide hole 666 formed in the upper mold 420. The guide hole 666 may allow the guide pin 428 to be inserted into the guide hole 666 to expose one end of the guide pin 428 to the internal space 430.

When molding resin is injected into the internal space 430 of the mold 400 at a predetermined pressure or higher, the guide pin 428 may be separated from the antenna pattern part 311 and may be retracted up to approximately a position at which the guide pin 428 does not protrude into the internal space 430. The number of elastic members 664 may correspond to the number of guide pins 428.

Since the molding resin is injected into the internal space 430 of the mold 400 at high pressure, pressure in the internal space 430 may increase instantaneously. Therefore, when the guide pin 428 works together with the elastic part 660 to be movable, the guide pin 428 which is in contact with the antenna pattern part 311 may be separated and retracted from the antenna pattern part 311 by the high pressure injection of the molding resin.

Since a large amount of molding resin is already injected into the internal space 430 when the guide pin 428 is retracted and the antenna pattern part 311 maintains a state in which it is continuously supported by the supporting pin 448 provided in the lower mold 440, the antenna pattern part 311 may not be exposed to one surface of the molding frame 320.

Meanwhile, at least one supporting groove 315 may be formed in the other surface of the molding frame 320. The supporting groove 315 may be formed by the supporting pin 448 of the lower mold 440 to support the antenna pattern part 311. Since the supporting pin 448 continuously supports the antenna pattern part 311 while the molding resin is provided in the overall internal space 430, the supporting groove 315 may be formed by removing the mold 400 after curing the molding resin.

As set forth above, the painting task is eliminated, whereby costs for manufacturing the radiator frame may be reduced and conductivity between the circuit board and the antenna frame may be improved.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A radiator frame comprising:
a radiator comprising an antenna pattern configured to transmit or receive a signal and a terminal connection configured to electrically connect the antenna pattern to a circuit board; and
a molding frame configured to embed the radiator,
wherein the antenna pattern is embedded in a first surface of the molding frame, and
the terminal connection is exposed to a second surface of the molding frame.

2. The radiator frame of claim 1, wherein a supporting groove is provided in a portion of the second surface of the molding frame.

3. The radiator frame of claim 1, wherein the antenna pattern is embedded in the molding frame to be spaced apart from one surface of the molding frame by about 0.2 mm.

4. The radiator frame of claim 1, wherein the radiator is embedded in the molding frame by injection-molding a resin.

5. The radiator frame of claim 1, wherein the antenna pattern is embedded in the molding frame to be spaced apart from one surface of the molding frame by about 0.2 mm to 0.5 mm.

6. The radiator frame of claim 1, wherein the antenna pattern and the terminal connection are disposed in different planes.

7. A mold for manufacturing a radiator frame, the mold comprising:
an upper mold comprising at least one guide pin;
a lower mold including a supporting pin, and the lower mold combines with the upper mold to provide an internal space to accommodate a radiator comprising an antenna pattern; and
a resin injector provided in at least one of the upper mold and the lower mold to inject a resin into the internal space;
wherein the at least one guide pin and the supporting pin fix the antenna pattern in the internal space, and
the at least one guide pin combines with an elastic part to be retractable by a pressure of the resin injected into the internal space.

8. The mold of claim 7, wherein the elastic part comprises:
an elastic member configured to have a first end attached to the guide pin;
a support member configured to support a second end of the elastic member;
a guide hole provided in the upper mold, and
the at least one guide pin is inserted into the guide hole and a end of the at least one guide pin exposed to the internal space.

9. The mold of claim 8, wherein the elastic member is a spring.

10. The mold of claim 8, wherein the quantity of the elastic member is equal to a quantity of the at least one guide pin.

11. The mold of claim 7, wherein the supporting pin protrudes into the internal space.

12. The mold of claim 7, wherein the upper mold has a groove of about 0.2 MM.

13. The mold of claim 8, wherein the end of the at least one guide pin exposed to the internal space is retracted in the guide hole, in response to the pressure of the injected resin.

14. The mold of claim 13, wherein the at least one guide pin does not protrude into the internal space.

15. The mold of claim 13, wherein the pressure of the resin injected into the internal space is sufficient to compress the elastic member.
